(19) United States
(12) Patent Application Publication
(10) Pub. No.: US 2011/0030504 A1
(43) Pub. Date: Feb. 10, 2011

(54) TORQUE-TRANSMITTING DEVICE COMPRISING AN OIL RECUPERATOR WIPER

(75) Inventor: Alexandre Leger, Gourdon (FR)

Correspondence Address: SUGHRUE MION, PLLC, 2100 PENNSYLVANIA AVENUE, N.W., SUITE 800, WASHINGTON, DC, 20037, US

(73) Assignee: ALSTOM Transport SA, Levallois Perret (FR)

(21) Appl. No.: 12/845,357

(22) Filed: Jul. 28, 2010

(30) Foreign Application Priority Data
Aug. 4, 2009 (FR) 0955494

(51) Int. Cl. F16H 57/04; F16H 57/02

(52) U.S. Cl. 74/606 R

(57) ABSTRACT

A torque-transmitting device including a casing inside which a gearwheel is mounted such that it can move by means of at least one rolling bearing housed in a side wall of the casing, the bottom of the casing being shaped to form an oil reserve in which part of the wheel is intended to be immersed, the casing additionally including an oil recuperator wiper arranged in the side wall housing the rolling bearing, above the latter. The oil recuperator wiper includes removable means of attachment to the casing, these means of attachment being accessible from outside the casing.

### BACKGROUND OF THE INVENTION

The invention relates to the lubrication of rolling bearings used in torque-transmitting devices, and relates in particular to the torque-transmitting devices used in applications requiring the transmission of very high torques. Such torque-transmitting devices are used, for example, in rail vehicles to transmit torque between an engine of the vehicle and an axle. They are commonly known as “reducers”.

The rolling bearings of such reducers are generally lubricated using pick-up lubrication or splash lubrication. The bottom of the reducer is filled with oil to form a reserve of oil that constantly covers some of the teeth of the gearwheel of the reducer. When the gearwheel is rotating, the oil picked up by the teeth is thrown against the walls of the casing and drops back down under gravity into spouts made in the internal faces of the walls and which open onto the rolling bearings. The oil crosses the rings of the rolling bearings and drops back into the oil reserve in the bottom of the casing.

When, after a fairly lengthy period of inactivity, the vehicle engine is started, the rolling bearings of such reducers may be insufficiently lubricated from the first turn of the engine. This is particularly critical when the ambient temperature is very low because the oil is then very viscous and is not immediately thrown against the walls of the casing. In addition, the lengths of the oil galleries that carry the oil to the rolling bearings is sometimes great which means that the time for which the rolling bearings do not receive their full level of lubrication may be long at low temperature: before the steady state speed is established, the rolling bearings may heat up rapidly and lead to seizures.

Document JP 59208268 discloses a differential reducer comprising a casing inside which a gearwheel is mounted such that it can move by means of at least one rolling bearing housed in a side wall of the casing, the bottom of the casing being shaped to form an oil reserve in which part of the wheel is immersed. An oil recuperation device is arranged in the side wall housing the rolling bearing, above the outer ring of the rolling bearing, and is designed to collaborate with the rim of the gearwheel.

This oil recuperation device is in the form of a funnel part of which is bolted to the internal face of the side wall. The oil thrown out as the wheel rotates is collected in this funnel and guided toward the rolling bearings by a nozzle.

This oil recuperation device is not, however, in direct contact with the rim of the gearwheel. As the gearwheel rotates, and at low temperatures, the oil is too viscous to be thrown into the funnel and cannot therefore provide the rolling bearings with effective lubrication.

### SUMMARY OF THE INVENTION

The device of the present invention is aimed at solving the problems of the devices of the prior art. It is notably aimed at starting off the lubricating of the rolling bearings at low temperature and/or at improving this lubrication during periods of operation at very low speed.

According to the invention, the torque-transmitting device according to the invention comprises a casing inside which a gearwheel is mounted such that it can move by means of at least one rolling bearing housed in a side wall of the casing. The bottom of the casing is shaped to form an oil reserve in which part of the wheel is intended to be immersed. The casing additionally comprises an oil recuperator wiper arranged in the side wall housing the rolling bearing, above the latter. The oil recuperator wiper according to the invention comprises removable means of attachment to the casing, these means of attachment being accessible from outside the casing.

The invention is advantageous in numerous respects: the oil recuperator wiper is able effectively to begin lubrication at low temperature, well before it begins naturally using the reserve of oil. Further, the fact that this recuperator wiper is readily removable means that the transmission device can be standardized: the recuperator wiper is simply added to it where necessary, notably for cold climates, and removed or not provided when the climate, being more temperate, does not require lubrication to be started off in this way, all the other components of the device remaining the same.

The torque-transmitting device of the invention may also comply with one of the following variants:

The oil recuperator wiper may comprise a substantially toric body housed in the side wall, a first end of which emerges out of the casing and a second end of which emerges into the casing, the second end comprising a blade extending substantially in the vertical direction, the blade at its free end having a surface that collaborates with the lateral periphery of the pinions of the gearwheel.

The substantially toric body may at the first end have a cavity housing a spring.

The free end of the blade may have a substantially convex cross section.

The recuperator wiper comprises a circular ring positioned on the blade.

The removable means of attachment may comprise a plate attached to a first end of the recuperator wiper, the plate on its peripheral perimeter comprising a first series of bores that complement a second series of bores that are formed on the exterior face of the side wall of the casing housing the recuperator wiper, and removable attachment elements arranged through the bores of the plate and of the casing.

The plate for example rests against the spring.

The inner face of the side wall housing the recuperator wiper may comprise at least one spout positioned between the oil recuperator wiper and the rolling bearing, the spout opening onto the rolling element.

A portion of the side wall may comprise a duct leading from the rolling bearing and opening into the bottom of the casing.

The bottom of the casing has a projection extending substantially in the vertical direction parallel to the side wall and dividing the bottom into two oil pans, at least one orifice in the projection allowing oil to flow between the two pans. It is also possible to provide several projections each equipped with at least one orifice, and delimiting more than two pans.

For preference, the oil recuperator wiper comprises a body equipped at one of its ends with a blade the free end of which extends in a direction perpendicular to the axis of rotation of said device and which collaborates with the lateral periphery of the pinions of the gearwheel.

This blade may be secured to the body by various means of attachment, of a mechanical type or by bonding for example. It is also possible to design a blade that is integral with the body, forming part thereof.

Advantageously, this blade is substantially symmetric with respect to a plane perpendicular to the plane contained in the gearwheel. With this feature, the recuperator wiper according to the invention can operate whatever the direction in which the gearwheel rotates, something which is particularly useful when the device of the invention is fitted to a rail vehicle which is called upon to change the direction in which it runs along the track.

The invention also relates to a recuperator wiper operating in both directions by virtue of this type of blade, whether or not its means of attachment to the casing are accessible from outside the casing.

### BRIEF DESCRIPTION OF THE DRAWINGS

Other objects, features and advantages of the invention will become apparent from reading the description of the embodiments of the torque-transmitting device, which description is given in conjunction with the figures in which:

FIG. 1 is a view in cross section of the torque-transmitting device comprising an oil recuperator wiper according to a first embodiment according to the invention,

FIG. 2 depicts a view in cross section of the oil recuperator wiper of the device according to FIG. 1,

FIG. 3 depicts a perspective view of an oil recuperator wiper according to a second embodiment of the invention.

### DETAILED DESCRIPTION OF THE INVENTION

To make the drawings easier to understand, only those elements needed for understanding the invention have been depicted. The same elements bear the same references from one drawing to another.

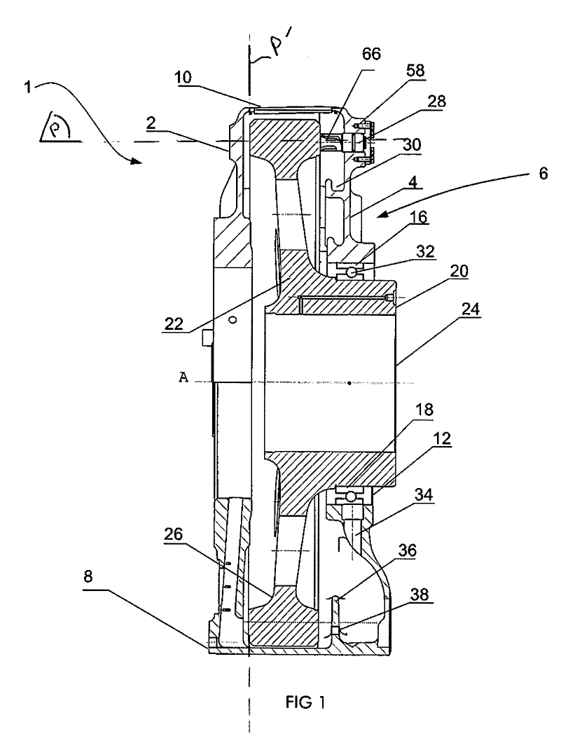

Throughout the present text “vertical”, “horizontal” or any other similar qualifier is to be understood as indicating the spatial positioning of the component in question in the most customary (but not necessarily only) configuration of operation of the torque-transmitting device, this configuration corresponding to the one depicted in FIG. 1.

The torque-transmitting device 1 illustrated in FIG. 1, is, for example, a locomotive reducer. This reducer 1 comprises a casing 2 formed of two half-parts, an upper part 4 and a lower part 8, and of a cover 10. Once closed, the casing 2 has two side walls running in a substantially vertical direction. The side wall 6 facing toward the engine (not depicted in the figure) comprises a rolling bearing 12, for example a ball bearing or roller bearing. The outer ring 16 of the rolling bearing 12 is secured to the side wall 6, while the inner ring 18 of the rolling bearing is secured to the hub 20 of a gearwheel 22. The gearwheel 22 is rotated by one end of a drive shaft 24 fitted with a pinion. The lower part 8 of the casing is filled with oil to form a reserve of oil in which at least part of a pinion 26 of the gearwheel 22 is immersed.

The side wall 6 housing the rolling bearing 12 comprises an oil recuperator wiper 28. This is arranged in the upper part 4, between the cover 10 and the outer ring 16 of the rolling bearing 12, so as to face the periphery of the pinions 26 of the gearwheel. Between the recuperator wiper 28 and the outer ring 16, at least one spout 30 is made on the inner face 31 of the side wall 6, the spout 30 opening onto the rolling element 32 (ball or roller). Under the outer ring 16, the side wall 6 has a duct 34 leading from the rolling bearing 32 and opening into the lower part 8. The bottom of the lower part 8 optionally comprises a projection 36 extending substantially in the vertical direction parallel to the side wall 6 and dividing the bottom into two oil pans forming a reserve. One or two orifices 38 are created in the projection 36 to allow flow between this reserve and the part from which the gearwheel picks up. The choice of the diameter of these openings sets the flow parameters.

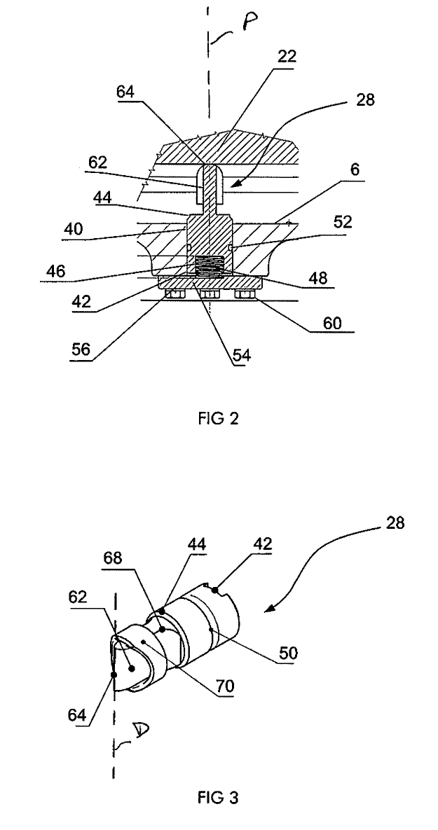

As illustrated in FIGS. 1 to 3, the recuperator wiper 28 comprises a substantially toric body 40, the axis of revolution of which is parallel to the axis of rotation A of the gearwheel 22, and housed in the side wall 6. A first end 42 of the body emerges out of the casing 2 and a second end 44 emerges inside the casing 2.

The substantially toric body 40 of the recuperator wiper has at its first end 42 a cavity 46 housing a spring 48. The body 40 of the recuperator wiper also comprises an annular groove 50 in which an O-ring 52 is mounted, to seal the casing 2. A plate 54 of substantially circular shape is attached to the first end 42 of the recuperator wiper emerging from the casing 2. The plate 54 thus rests against the spring 48 and compresses it. The end 42 of the recuperator wiper and the plate 54 comprise removable means of attachment to one another, for example formed of notches on the body of the recuperator wiper and mating pins on the plate. Other means of attachment may be imagined, such as a system of paired bores on the body of the recuperator wiper and the plate. The plate 54 on its peripheral perimeter comprises a series of bores 56. The exterior face of the side wall of the casing housing the recuperator wiper also comprises a series of identical bores 58, which therefore complement one another when the bores 56 of the plate are positioned facing the bores 58 of the casing. Removable attachment elements 60 such as screws are positioned through the coaxial bores 58, 56 of the plate and of the casing in order to join the recuperator wiper 28 to the casing 2, via the plate 54. These attachment elements 60 are accessible from outside the casing.

The second end 44 of the recuperator wiper body, which emerges inside the casing 2, comprises a blade 62 extending substantially in a vertical direction D which is perpendicular to the axis of rotation A of the gearwheel which is itself horizontal in this instance. This blade at its free end 64 has a surface collaborating with the lateral periphery of the pinions 26 of the gearwheel 22 situated facing the side wall 6. The free end 64 of the blade, in a horizontal plane substantially parallel to the bottom of the casing, has a substantially convex cross section. The blade on its vertical faces comprises a groove 66 of convex shape, substantially horizontal near the contact surface 64 and substantially vertical near the flanks of the end 44, so as to guide the oil wiped from the wheel 22 into the spout 30. The blade has symmetry with respect to the plane P perpendicular to the plane P′ containing the gearwheel (here passing through the front face thereof), and this allows it to perform its function irrespective of the direction in which the wheel rotates with respect to its axis A.

In a variant depicted in FIG. 3, the blade 62 has no groove 66. The blade is connected to the body 40 by two connecting flanks 68 of substantially concave cross section. The recuperator wiper 28 additionally comprises a circular ring 70 arranged on the blade 62 in such a way as to touch neither the gearwheel 22 nor the body of the recuperator wiper 40.

The way in which the torque-transmitting device works will now be described. When stationary, at least one pinion 26 of the gearwheel 22 is immersed—or partially immersed depending on the oil level—in the reserve of oil. The end 64 of the blade 62 of the recuperator wiper 28 is kept pressed against the wheel 22 by the compressive stress exerted by the plate 54 on the spring 48. When the engine starts, the drive shaft 24 turns the gearwheel 22. Right from the first turn of the wheel, the end 64 of the blade rubs against the periphery of the gearwheel 26 laden with oil. Thanks to the groove 66 in the blade 62—or thanks to the shape of the blade 62 and to the circular ring 70 which acts as a ducting means in the second variant—the wiped oil is guided toward the spout 30 positioned under the recuperator wiper, into which it falls under gravity. Again under gravity, the oil passes across the rolling elements 32 and returns to the bottom of the casing via the duct 34 formed in the side wall 6. The projection 36 is arranged in such a way as to create a pan independent of the reserve of oil in which part of the gearwheel 22 is immersed. Under steady state conditions the oil, the temperature of which has increased, is guided toward the spout 30 by the recuperator wiper 28 and is also thrown against the side walls of the casing 2 by pick-up lubrication.

A device such as this makes it possible, in extremely cold weather, right from the first turn of the wheel and even at very low speeds (typically of below 10 km/h) for the spout 30 to be filled and the rolling elements 32 lubricated effectively.

The spring 48 housed in the recuperator wiper 28 allows the recuperator wiper 28 always to be kept in contact with the gearwheel 22, even in the event of geometric defects with the wheel or wear of the contacting parts. The load generated by the spring is rated to avoid premature recuperator wiper wear.

The recuperator wiper 28 or one of the components thereof can easily be changed or undergo maintenance by removing the attachment elements 60 which are accessible from outside the casing 2, without any need to open up the casing 2 of the torque-transmitting device.

The torque-transmitting device 1 according to the invention is of a simple design, is easy to maintain, and lubricates the rolling bearings even when the oil is viscous, right from the first turn of the wheel. The device remains effective at very low speeds and becomes surplus to requirement at higher speeds, without disrupting the splash lubrication.

Of course, the invention is not in any way restricted to the embodiments described and illustrated which have been given merely by way of examples.

1. A torque-transmitting device comprising a casing inside which a gearwheel is mounted such that it can move about an axis of rotation by means of at least one rolling bearing housed in a side wall of the casing, the bottom of the casing being shaped to form an oil reserve in which part of the wheel is intended to be immersed, the casing additionally comprising an oil recuperator wiper arranged in the side wall housing the rolling bearing, above the latter, wherein the oil recuperator wiper comprises removable means of attachment to the casing, these means of attachment being accessible from outside the casing.

2. The torque-transmitting device as claimed in claim 1, wherein the oil recuperator wiper comprises a body equipped at one of its ends with a blade the free end of which extends in a direction perpendicular to the axis of rotation of said device and which collaborates with the lateral periphery of the pinions of the gearwheel.

3. The torque-transmitting device as claimed in claim 1, wherein the blade is substantially symmetric with respect to a plane perpendicular to the plane contained in the gearwheel.

4. The torque-transmitting device as claimed in claim 1, wherein the oil recuperator wiper comprises a substantially toric body housed in the side wall, a first end of which emerges out of the casing and a second end of which emerges into the casing, the second end comprising a blade extending substantially in the vertical direction, the blade at its free end having a surface that collaborates with the lateral periphery of the pinions of the gearwheel.

5. The torque-transmitting device as claimed in claim 1, wherein the oil recuperator wiper comprises a body, particularly a substantially toric body, which at one of its ends emerging from the casing has a cavity housing a spring.

6. The torque-transmitting device as claimed in claim 2, wherein the free end of the blade has a substantially convex cross section.

7. The torque-transmitting device as claimed in claim 1, wherein the recuperator wiper comprises a circular ring positioned on the blade.

8. The torque-transmitting device as claimed in claim 1, wherein the removable means of attachment comprise a plate attached to a first end of the recuperator wiper emerging from the casing, the plate on its peripheral perimeter comprising a first series of bores that complement a second series of bores that are formed on the exterior face of the side wall of the casing housing the recuperator wiper, and removable attachment elements arranged through the bores of the plate and of the casing.

9. The torque-transmitting device as claimed in claim 5, wherein the plate rests against the spring.

10. The torque-transmitting device as claimed in claim 1, wherein the inner face of the side wall housing the oil recuperator wiper comprises at least one spout positioned between the oil recuperator wiper and the rolling bearing, said spout opening onto the rolling element.

11. The torque-transmitting device as claimed in claim 1, wherein a portion of the side wall comprises a duct leading from the rolling bearing and opening into the bottom of the casing.

12. The torque-transmitting device as claimed in claim 1, wherein the bottom of the casing has a projection extending substantially in the vertical direction parallel to the side wall and dividing the bottom into two oil pans, at least one orifice in the projection allowing oil to flow between the two pans.
